(19) United States
(12) Patent Application Publication
(10) Pub. No.: US 2021/0300738 A1
(43) Pub. Date: Sep. 30, 2021

(54) GROUND ROD GRABBER

(71) Applicant: IES Residential, Inc., Stafford, TX (US)

(72) Inventors: Guy Darwin FISH, Missouri City, TX (US); George Stephen TIDDEN, Katy, TX (US)

(21) Appl. No.: 17/192,372

(22) Filed: Mar. 4, 2021

Related U.S. Application Data
(60) Provisional application No. 62/994,318, filed on Mar. 25, 2020.

(51) Int. Cl. B66F 9/06; H02G 1/00

(52) U.S. Cl. CPC B66F 9/06; H01R 4/66; H02G 1/00

(57) ABSTRACT

An apparatus includes a support attachment to couple a ground rod grabber to a top support; an upper line coupled to the support attachment; a hoist unit coupled to the upper line; a rod attachment to couple the ground rod grabber to a ground rod; and a lower line coupled to the rod attachment and threaded through the hoist unit. A method includes coupling a ground rod grabber to a ground rod; coupling the grabber to a top support while retaining at least two dimensions of freedom; and operating the hoist unit to exert pulling force on the lower line. A device includes a tube having a length-wise window; a threaded shaft disposed within the tube; a nut threaded on the threaded shaft within the tube; and a lifting lug coupled to the nut, extending through the window, and having a hole sized to fit a ground rod.

### CROSS REFERENCE TO RELATED APPLICATIONS

This application claims benefit of U.S. Provisional Patent Application Ser. No. 62/994,318, filed Mar. 25, 2020, entitled “Ground Rod Grabber,” which is incorporated herein by reference.

### BACKGROUND

This disclosure is related generally to the field of electrical wiring installations. Electrical wiring can include, for example, metallic, and/or fiber optic cabling, among others. This disclosure may have applications in grounding of electrical systems, for example, to limit voltage induced on metal parts by lightning, line surges, or unintentional contact by higher-voltage lines.

The National Electric Code Grounding and Bonding articles require that electrical systems be solidly connected to the earth. In most cases, this solid connection to the earth is achieved by driving a ground rod (e.g., an 8 foot long steel or copper rod) almost entirely into the ground and connecting the upper end of the rod to the electrical system by means of a grounding electrode conductor. When the ground rod is no longer needed (e.g., at closing of temporary electrical service installations), the ground rod may be decommissioned. For example, the ground rod may be decommissioned by driving the ground rod further into the earth or by removal of the ground rod from the work site. In the first instance, leaving ground rods behind may be environmentally harmful and/or could cause difficulties in future development projects at the site. Moreover, the full equipment cost of the abandoned ground rods adds to the cost of the project. However, removal of the ground rods can be difficult. If done manually, workers risk injury negotiating extensive forces to extract a long rod from possibly-compacted soil. Forces applied often result in bending or kinking of the ground rod during removal. Thus, reuse of the removed ground rods may not be possible, again adding equipment cost to the cost of the project.

It would be beneficial to be able to extract ground rods quickly, efficiently, safely and without such damage that would prevent reuse of the ground rod.

### BRIEF SUMMARY

In an embodiment, a ground rod grabber includes a support attachment configured to couple the ground rod grabber to a top support; an upper line coupled at a first end to the support attachment; a hoist unit coupled to the upper line at a second end of the upper line; a rod attachment configured to couple the ground rod grabber to a ground rod; and a lower line coupled at a third end to the rod attachment and threaded through the hoist unit.

In an embodiment, a method of ground rod extraction includes coupling a ground rod grabber to a ground rod with a rod attachment, wherein the ground rod grabber comprises: the rod attachment; a support attachment; a hoist unit; and a lower line threaded through the hoist unit; coupling the ground rod grabber to a top support with the support attachment such that, when coupled, the support attachment retains at least two dimensions of freedom relative to the top support; and operating the hoist unit to exert pulling force on the lower line.

In an embodiment, a ground rod grabber includes a tube having a length-wise window; a threaded shaft disposed within the tube; a nut threaded on the threaded shaft within the tube; and a lifting lug coupled to the nut, extending through the window, and having a hole sized to fit a ground rod.

### BRIEF DESCRIPTION OF THE DRAWINGS

So that the manner in which the features of the present disclosure can be understood in detail, a more particular description of the disclosure may be had by reference to embodiments, some of which are illustrated in the appended drawings. It is to be noted, however, that the appended drawings illustrate only exemplary embodiments and are therefore not to be considered limiting of its scope, which may apply to other equally effective embodiments.

FIG. 1 illustrates several exemplary ground rods.

FIG. 2 illustrates common usage of ground rods.

FIG. 3 illustrates an exemplary ground rod grabber.

FIG. 4A illustrates use of the ground rod grabber of FIG. 3 to extract a ground rod from the earth. FIG. 4B further illustrates use of the ground rod grabber of FIG. 3 to extract a ground rod from the earth.

FIG. 5A illustrates another exemplary ground rod grabber. FIG. 5B illustrates usage of a top support of the ground rod grabber of FIG. 5A. FIG. 5C illustrates an exemplary upper line configuration for the ground rod grabber of FIG. 5A.

FIG. 6 illustrates another exemplary ground rod grabber.

FIG. 7 illustrates another exemplary ground rod grabber.

FIG. 8A illustrates an exemplary use of the ground rod grabber of FIG. 5A to extract a ground rod from the earth. FIG. 8B illustrates another exemplary use of the ground rod grabber of FIG. 5A to extract a ground rod from the earth.

FIG. 9 illustrates another exemplary use of the ground rod grabber of FIG. 5A to extract a ground rod from the earth.

FIG. 10 illustrates an exemplary method for utilizing a ground rod grabber.

### DETAILED DESCRIPTION

It is to be understood the present disclosure is not limited to particular devices or methods, which may, of course, vary. It is also to be understood that the terminology used herein is for the purpose of describing particular embodiments only, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects.

As used herein, the term “axial” or “axial direction” shall mean, for an object or system having a canonical axis, a direction along a proximal portion of the axis.

As used herein, the term “lateral” or “lateral direction” shall mean, for an object or system having a canonical axis, a direction perpendicular to a proximal portion of the axis.

As used herein, the term “line” shall mean a flexible, axial load carrying member. Such a line may be made from rope, cable, chain, fiber, steel, other high strength material, or any combinations thereof.

If there is any conflict in the usages of a word or term in this specification and one or more patent or other documents that may be incorporated herein by reference, the definitions that are consistent with this specification should be adopted for the purposes of understanding this disclosure.

The present disclosure generally relates to electrical wiring installations methods and apparatuses, and, at least in some embodiments, to novel equipment for handling and/or extracting ground rods, and associated methods of use of such equipment.

Some embodiments of this disclosure may advantageously improve ground rod installation and/or removal procedures for electrical wiring installation projects. For example, use of a ground rod grabber may reduce or eliminate damage to ground rods during installation and/or removal. In some embodiments, the use of a ground rod grabber may reduce risk of worker injury during ground rod installation and/or removal. In some embodiments, the use of ground rod grabbers may provide for more efficient electrical wiring installation projects due to quicker extraction of ground rods at the conclusion of the project. Some embodiments of this disclosure may advantageously provide for safer and more efficient installation and/or removal of ground rods from the earth. Some embodiments of this disclosure may advantageously eliminate the need for brute force and/or primitive tools, allowing a single worker to remove a ground rod from the earth with a safe and efficient force. Disclosed ground rod grabbers are advantageously portable and reconfigurable. For example, the use of snap hooks or similar attachment devices in the reconfigurable design of the ground rod grabber allows function as a hoist or pull. Moreover, utilization of appropriately-sized wire/cable grip as the rod attachment allows for extraction of any size standard cylindrical ground rod. Embodiments of the present disclosure can thereby be useful in the implementation and/or operation of electrical wiring installations.

In the construction industry, electrical contractors are typically responsible for removing temporary electric service installations (e.g., once the electric service is switched from temporary to permanent by the electric utility company). Often, a single service technician will be tasked with removal of all temporary service equipment, including ground rods. Such service technicians are not expected to have access to heavy lifting equipment, having a limited space for tools on their small-load vehicles. Therefore, a criteria for equipment for ground rod extraction is portability. Solutions for ground rod extraction that require bulky tools and/or large support structures are not suitable for such single-man operations. Ground rod grabbers discussed herein may be portable, being either self-supporting or capable of attaching to supports that are expected to be readily available on typical construction sites.

Additionally, industry guidelines (e.g., OSHA ergonomics recommendations) recognize repetitive excessive force on pressure points such as lower back, knees, arms, wrists and hand as one of the primary risk factors for workplace injuries and musculoskeletal disorders. A single-man operation, such as removal of temporary service equipment, including ground rods, must heed industry guidelines. Equipment to be carried by a single person (e.g., single-man lift) should be within appropriate weight and dimension guidelines. Usage of equipment should constrain application of forces to load and lever-arm ranges appropriate for comfortable and safe working heights. Ground rod grabbers discussed herein may minimize the amount of force required from the operator for pulling ground rods from the earth. The disclosed ground rod grabbers may also protect the operator by allowing the individual to maintain an upright body posture during the rod extraction process, reducing or eliminating musculoskeletal risk factors associated with excessive bending and twisting while exerting force.

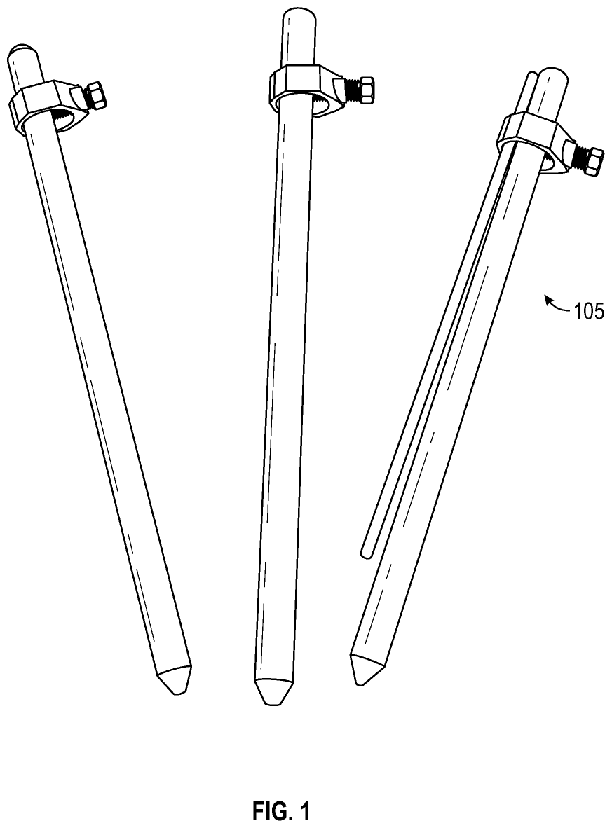

FIG. 1 illustrates several exemplary ground rods, such as ground rod 105. Common ground rods may be about 4 feet to about 12 feet in length, for example, 8 feet. The length of the ground rods may be specified by regulation or code. The length of the ground rods utilized at a particular electrical wiring installation project may be selected to better reach bedrock below the earth's surface. Common ground rods may be made of conductive, corrosion-resistive metal, such as copper-bonded, galvanized, and/or stainless steel. Some ground rods may have a steel core. The length and diameter of the ground rod may affect the rod's resistance/conductivity and/or driving characteristics.

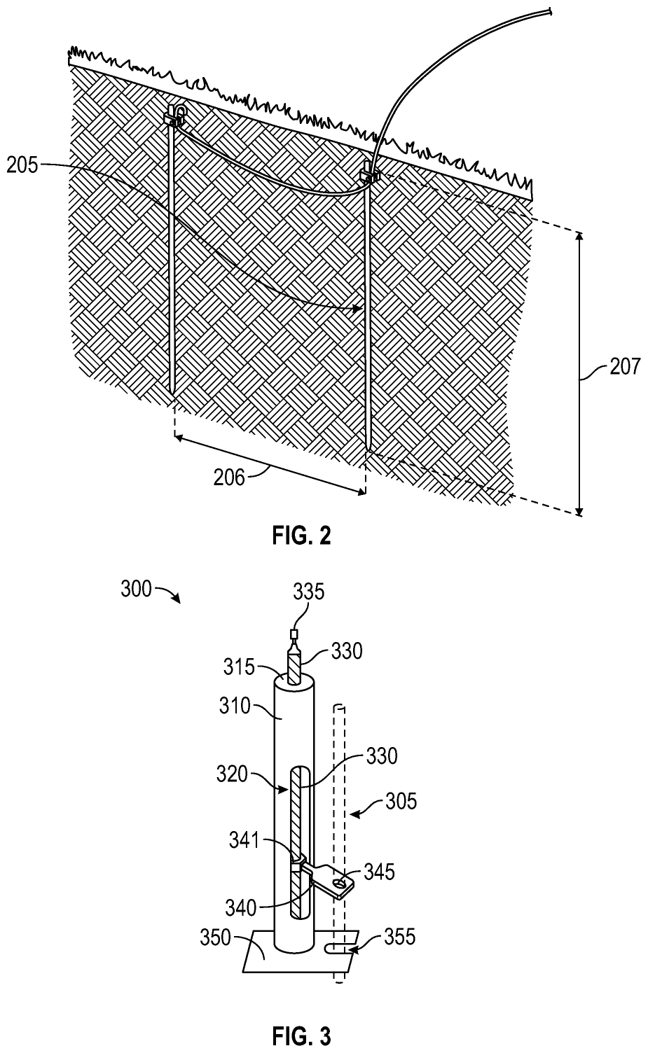

FIG. 2 illustrates common usage of ground rods, such as ground rod 205. Regulatory requirements specify the number, length, and location of ground rods to be utilized at an electrical wiring installation project. For example, as illustrated in FIG. 2, the distance 206 between ground rod 205 and the next closest ground rod is not less than about 6 feet. Also as illustrated, the length 207 of ground rod 205 may be about 8 feet. Larger projects may require placement of additional rods. Installation of a ground rod typically involves driving a long, mostly steel rod into the earth and connecting a ground wire to it. Since the ground rods are typically installed into the earth by driving force, the outer surface of the ground rod may be selected to be smooth to minimize friction with the earth during installation. Application of a driving force from higher than 4 feet above the surface of the ground may not be physically possible with manual equipment (e.g., a sledge hammer). Long rods may bow when being driven. The more a rod bows or shudders, the less efficient the driving process is.

Once an electrical wiring installation project has been completed, the temporary electrical service ground rods may be decommissioned, either by driving the ground rods further into the earth or by removal of the ground rods from the site. In the first instance, leaving ground rods behind may be environmentally harmful and/or could cause difficulties in future development projects at the site. Moreover, the full equipment cost of the abandoned ground rods adds to the cost of the project. However, removal of the ground rods can be difficult. If done manually, workers risk injury negotiating extensive forces to extract a long rod from possibly-compacted soil. Forces applied often result in bending or kinking of the ground rod during removal. Thus, reuse of the removed ground rods may not be possible, again adding equipment cost to the cost of the project.

FIG. 3 illustrates an exemplary ground rod grabber 300 according to embodiments disclosed herein. The ground rod grabber 300 may include a tube 310, such as a heavy-duty steel tube. The tube 310 may have a length-wise (e.g., vertical in FIG. 3) window 320, such as a slot, on one side. A shaft 330, such as a threaded shaft, may be fitted through the center of the tube 310, along a central axis thereof. The shaft 330 may be coupled to the tube 310 so that it can rotate relative to the tube 310 while being fixed axially within the tube 310. For example, an end piece 315 of the tube 310 may maintain the shaft 330 at or near the radial center of the tube 310. In some embodiments, shaft 330 may have a tool tip 335, such as a drill-bit tip, that can be utilized to provide rotational forces to shaft 330. The exterior of the shaft 330 may be threaded. In some embodiments, the ground rod grabber 300 may include a coarsely-threaded shaft to provide robust extraction forces to a ground rod 305. A bolt 340 may be secured to the shaft 330. For example, the bolt 340 may have a threaded nut 341 coupled (e.g., welded) at the end proximal to the shaft 330. The threaded nut 341 may be threaded onto the shaft 330. The interior of the tube 310 may be hollow and sufficiently broad to allow free motion, e.g. rotation, of the nut 341 around the shaft 330, and thereby lengthwise movement of the nut 341 with the bolt 340 along the longitudinal length of the shaft 330 in response to the engagement between the internal threading on the nut 341 and the external threading on the shaft 330. The bolt 340 may be coupled (e.g., welded) to a lifting lug 345. For example, the lifting lug 345 may be disposed near or at the end of the bolt 340 distal from the shaft 330. In some embodiments, the lifting lug 345 has a hole sized to fit ground rod 305. The window 320 of the tube 310 may be sufficiently broad to allow free motion of the bolt 340 with the lifting lug 345 as the nut 341 moves lengthwise along the shaft 330. The bolt 340 extends from the nut 341 to the exterior of the tube 310 through the window 320 of the tube 310. In some embodiments, lifting lug 345 is coupled to the bolt 340 at an angle other than 90 degrees (e.g. 60 degrees) with respect to the shaft of the bolt 340. For example, an angle other than 90 degrees may provide a friction force between the lifting lug 345 and the ground rod 305 sufficient to hold the ground rod 305 against opposing forces (e.g., gravity and/or ground friction). In other embodiments, the lifting lug 345 may be coupled to the bolt at about a 90-degree angle with respect to the shaft of the bolt 340. In such embodiments, a rod-gripping device, such as a wire grip, a cable grip, a friction plate, or a friction-grip device connected between the lifting lug 345 and the ground rod 305 may provide an axial force for holding the ground rod 305 against opposing forces. A lower end of the tube 310 may include a base plate 350. In some embodiments, the base plate 350 may maintain the shaft 330 at or near the radial center of the tube 310, in addition to, or in lieu of, an end piece 315 at the other end of the tube 310. In some embodiments, the base plate 350 may include a notch 355 on the same side of the tube 310 as the window 320.

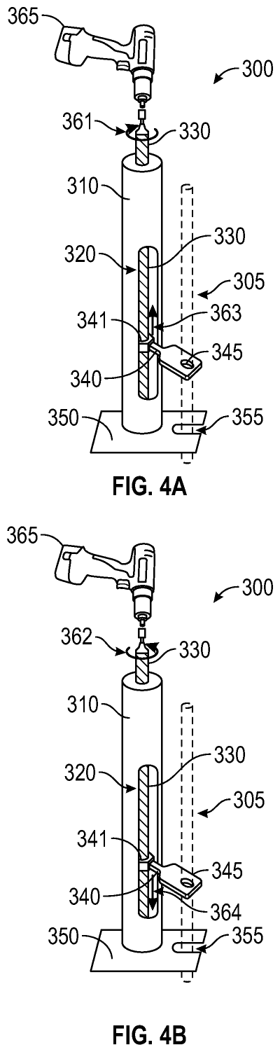

FIG. 4A illustrates use of the ground rod grabber 300 to extract a ground rod 305 from the earth. The ground rod grabber 300 is placed near the ground rod 305. For example, an exposed portion of the ground rod 305 may be positioned within the notch 355 of the base plate 350 such that the ground rod 305 extends through the notch 355 of the base plate 350. The base plate notch 355 may wrap at least partially around the exterior of the ground rod 305 to better secure the ground rod grabber 300 to the ground rod 305. In addition, the lifting lug 345 may be coupled to the exposed portion of the ground rod 305. For example, an exposed tip of the ground rod 305 may be inserted through the hole of the lifting lug 345. In some embodiments, the ground rod grabber 300 is manually lifted above and near the ground rod 305 and then set down on top of the ground rod 305 such that the notch 355 in the base plate 350 surrounds the ground rod 305, and the exposed portion of the ground rod 305 is inserted through the hole of the lifting lug 345. In this position, the bolt 340 and the lifting lug 345 may be located at the lower end of the window 320 of the tube 310 closest to the base plate 350 so that the bolt 340 and the lifting lug 345 can move upward along the full length of the shaft 330 and the window 320 to pull out the same length of the ground rod 305 from the earth. The coupling may provide a higher frictional force between the lifting lug 345 and the ground rod 305 in one direction than in the other direction. Once the ground rod 305 is secured to the lifting lug 345, upward movement 363 of the nut 341 along the length of the shaft 330 will translate to upward movement of the bolt 340 with the lifting lug 345, and thereby upward movement of the ground rod 305 relative to the earth. For example, clockwise rotation 361 of the shaft 330 will cause upward movement of the nut 341 (with the bolt 340 and the lifting lug 345) along the shaft 330, and thereby upward movement of the ground rod 305 by the lifting lug 345 pulling up on the ground rod 305. As the shaft 330 is rotated clockwise, the threads between the shaft 330 and nut 341 force the nut 341 upward along the shaft 330. This is the force that is transmitted through the lifting lug 345 to the ground rod 305 to lift the ground rod 305 out of the ground.

In some embodiments, the top end of the shaft 330 may extend outside the tube 310 (e.g., above the end piece 315). In some embodiments, the shaft 330 may have the tool tip 335 at the top end. A tool 365, such as a drill, may be coupled to the shaft 330 via the tool tip 335. The tool 365 may rotate the shaft 330 clockwise, thereby extracting the ground rod 305 from the earth.

In some embodiments, a coupling between the lifting lug 345 and the ground rod 305 may provide for high frictional forces as the lifting lug 345 moves upward, extracting the ground rod 305, while the coupling may reduce or release the frictional forces as the lifting lug 345 moves downward. Alternatively rotating the shaft 330 clockwise and counterclockwise may then apply primarily extraction (e.g., upward) forces on the ground rod 305. For example, FIG. 4B further illustrates use of the ground rod grabber 300 to extract the ground rod 305 from the earth. As illustrated in FIG. 4A, the upward movement 363 of the nut 341 along the length of the shaft 330 may continue until the bolt 340 and the lifting lug 345 are located near or at the upper end of the window 320 of the tube 310 furthest from the base plate 350. From such position, the rotation of the shaft 330 may be reversed so that the nut 341 with the bolt 340 and the lifting lug 345 may move downward along the full length of the shaft 330 and the window 320. The coupling between the lifting lug 345 and the ground rod 305 may provide for high frictional forces as the lifting lug 345 moves upward, while the coupling may reduce or release the frictional forces as the lifting lug 345 moves downward. Therefore, downward movement 364 of the nut 341 (with the bolt 340 and the lifting lug 345) along the length of the shaft 330 will translate to little or no movement of the ground rod 305 relative to the earth. For example, counterclockwise rotation 362 of the shaft 330 will cause downward movement of the nut 341, the bolt 340, and the lifting lug 345. The lifting lug 345 will thereby move downward relative to the ground rod 305. As the shaft 330 is rotated counterclockwise, the threads between the shaft 330 and nut 341 force the nut 341 downward along the shaft 330. Once the nut 341 with the bolt 340 and the lifting lug 345 have moved downward near or at the lower end of the window 320, the shaft 330 may then again be rotated clockwise to further lift the ground rod 305 from the ground. This lifting process described with respect to FIGS. 4A and 4B may be repeated any number of times as needed to fully extract the ground rod 305 from the ground. Use of the ground rod grabber 300 may apply upward forces to the ground rod 305, extracting the ground rod 305 straight up, without bends or damages to the material.

In some embodiments, as in FIG. 4A, the top end of the shaft 330 may extend outside the tube 310 (e.g., above the end piece 315). In some embodiments, shaft 330 may have the tool tip 335 at the top end. The tool 365, such as a drill, may be coupled to the shaft 330 via the top end. The tool 365 may rotate the shaft 330 counterclockwise, thereby releasing the frictional forces between the lifting lug 345 and the ground rod 305.

In some embodiments, a gear system (e.g., with rotary handle) may be installed atop the shaft 330, allowing for manual rotation of the shaft 330 in order to make the ground rod grabber 300 usable in absence of a drill. In some embodiments, the ground rod grabber 300 may include guards and/or safety features, for example, to prevent accidental contact with moving parts. In some embodiments, a ground rod grabber 300 may be used to drive and/or extract rebar, pipes, posts, steaks, etc. from the earth or other material.

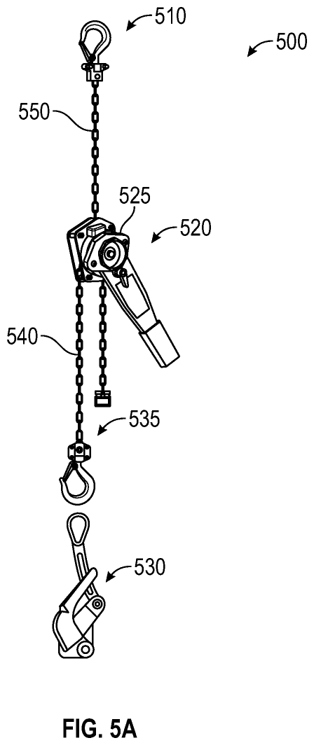

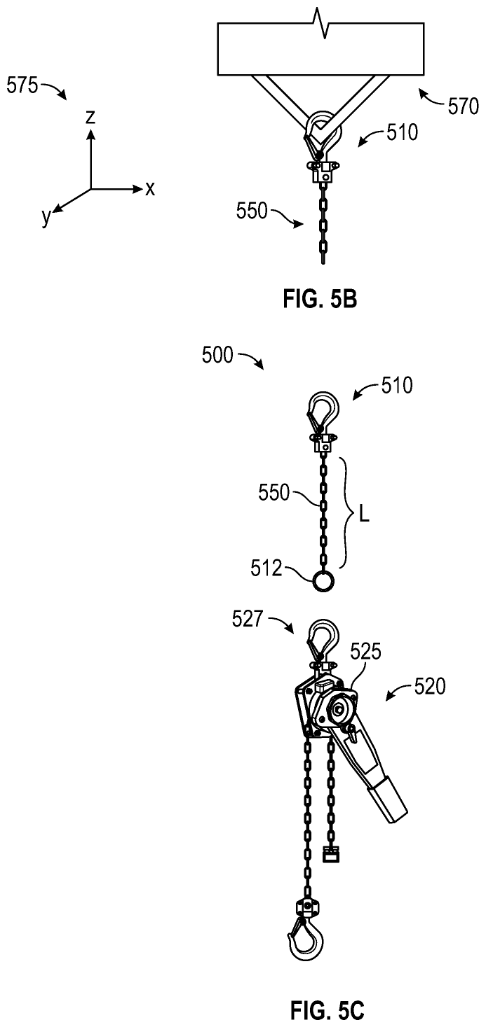

FIG. 5A illustrates an exemplary ground rod grabber 500 according to embodiments disclosed herein. The ground rod grabber 500 may include a support attachment 510, a hoist unit 520, a rod attachment 530, and a lower line 540.

The support attachment 510 may be configured to couple to a top support 570. For example, as illustrated in FIG. 5B, the top support 570 may provide a fixed, vertical support for the ground rod grabber 500. As discussed below, the top support 570 may be an existing structure at a work site. In some embodiments, the support attachment 510 may be configured to couple to the top support 570 such that, when coupled, the support attachment 510 retains at least two dimensions of freedom relative to the top support 570. For example, as illustrated in FIG. 5B, when the support attachment 510 is coupled to the top support 570, the support attachment 510 may rotate (relative to top support 570) about axes in two lateral directions (e.g., rotation about the X-axis (in the Y-Z plane) and rotation about the Y-axis (in the X-Z plane), as indicated by reference axes 575). In some embodiments, the support attachment 510 may include a clip hook, carabiner, quick-release clamp, locking clamp, other similar attachment mechanisms, or any combination thereof. In some embodiments, a suitable attachment mechanism may be coupled and/or decoupled by single-hand manipulation. The support attachment 510 may thus be capable of quickly coupling and/or decoupling with the top support 570, while still being capable of transferring axial load thereto. In some embodiments, the support attachment 510 may be capable of withstanding an axial load sufficient for removal of a ground rod from the earth. For example, the support attachment 510 may be capable of withstanding an axial load of at least 500 pounds.

The lower line 540 may be threaded through the hoist unit 520. The hoist unit 520 may include one or more pulleys to manipulate the lower line 540. For example, the hoist unit 520 may include a lift mechanism, such as a pulley, a block of pulleys, a ratchet hoist, a come-along, a multi-pulley device, a block-and-tackle, and/or any combination thereof. The hoist unit 520 may be configured to exert an axial load on lower line 540, thereby retracting lower line 540 through the one or more pulleys. In some embodiments, the hoist unit 520 may include a ratchet 525. In such embodiments, ratchet 525 may resist axial forces on lower line 540 in the direction away from hoist unit 520. Moreover, hoist unit 520 may be configured to apply axial load to lower line 540 more efficiently and safely than would be possible by an operator simply pulling on lower line 540. For example, hoist unit 520 may include a block-and-tackle arrangement to multiply axial load forces. For example, ratchet 525 may include a lever arm to convert rotational force to axial load force. This may allow for the operator to more safely manipulate lower line 540. Additionally, ratchet 525 may include a long lever arm to multiply the rotational force into a higher axial load force. In some embodiments, the hoist unit 520 may be capable of applying an axial load sufficient for removal of a ground rod from the earth. For example, the hoist unit 520 may be capable of applying an axial load of at least 500 pounds to lower line 540.

The rod attachment 530 may be coupled to the lower line 540. For example, lower line 540 may have, at its lower end, a coupling 535. The rod attachment 530 may thus be capable of quickly coupling and/or decoupling with lower line 540, while still being capable of transferring axial load thereto. In some embodiments, the coupling 535 may include a clip hook, a carabiner, quick-release clamp, locking clamp, other similar attachment mechanisms, or any combination thereof. In some embodiments, a suitable attachment mechanism may be coupled and/or decoupled by single-hand manipulation. The rod attachment 530 may include a rod-gripping device, such as a wire grip, cable grip, friction plate, friction-grip device, or other rod-gripping device capable of providing an axial force for holding a ground rod against opposing forces (e.g., gravity and/or ground friction). For example, a rod-gripping device may apply a lateral force to the ground rod with a clamp to increase the friction force between the clamp and the ground rod. The rod attachment 530 may thus be capable of quickly coupling and/or decoupling with a ground rod, while still being capable of transferring axial load thereto. In some embodiments, the rod attachment 530 may be capable of withstanding an axial load sufficient for removal of a ground rod from the earth. For example, the rod attachment 530 may be capable of withstanding an axial load of at least 500 pounds.

In some embodiments, ground rod grabber 500 may also include an upper line 550 coupled between the hoist unit 520 and the support attachment 510. For example, as illustrated in FIG. 5A, upper line 550 may provide a fixed distance between hoist unit 520 and the support attachment 510. For example, upper line 550 may be a fixed-length line. As another example, as illustrated in FIG. 5C, upper line 550 may provide an adjustable distance between hoist unit 520 and the support attachment 510. In some embodiments, upper line 550 may be an adjustable-length line. As illustrated in FIG. 5C, upper line 550 may provide an adjustable distance between hoist unit 520 and the support attachment 510 while being a fixed-length line. As illustrated, ring 512 (coupled to an end of upper line 550) may be utilized with hook 527 (coupled to hoist unit 520) to adjust the distance between hoist unit 520 and the support attachment 510. By simply coupling hook 527 to ring 512, the distance between hoist unit 520 and support attachment 510 is the length L of upper line 550. By threading upper line 550 through hook 527 and coupling ring 512 to support attachment 510, the distance between hoist unit 520 and support attachment 510 is L/2 (length divided by 2). By threading upper line 550 through both hook 527 and support attachment 510, and then coupling ring 512 to hook 527, the distance between hoist unit 520 and support attachment 510 is L/3 (length divided by 3). Repeating this process may allow for further reduction of the distance between hoist unit 520 and support attachment 510 while maintaining a fixed-length L of the upper line 550. An adjustable distance between hoist unit 520 and the support attachment 510 may allow for usage of ground rod grabber 500 with a variety of different top supports 570. For example, the initial length of lower line 540 may be selected to position hoist unit 520 at a safe working height. The distance between hoist unit 520 and the support attachment 510 may then be set to maintain the safe working height of hoist unit 520 while still coupling to a top support 570 which, as an existing structure at the work site, is at a pre-set height. It should be appreciated that upper line 550 may provide for an adjustable distance between the hoist unit 520 and the support attachment 510 with a variety of other arrangement and/or mechanisms in addition to, or in lieu of, ring 512 and hook 527, while still retaining the portability of ground rod grabber 500.

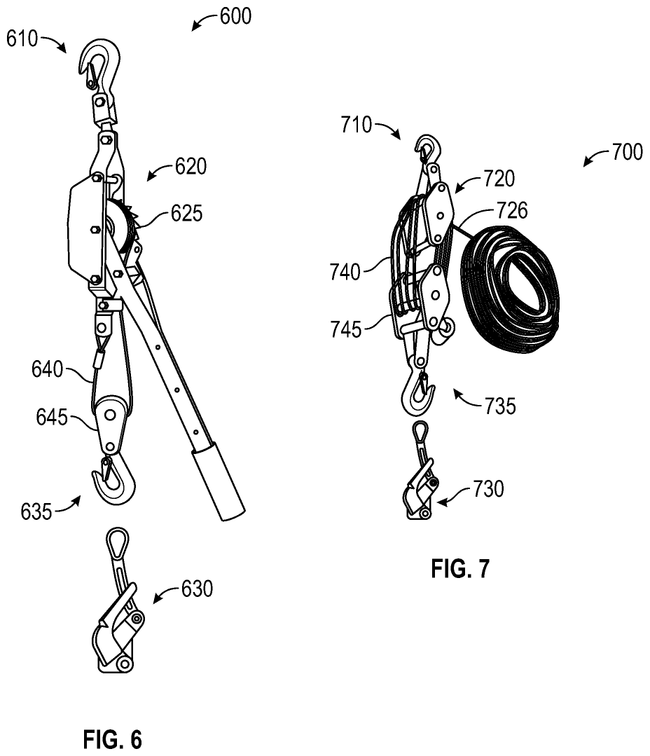

FIG. 6 illustrates an exemplary ground rod grabber 600 according to embodiments disclosed herein. Similar to ground rod grabber 500, ground rod grabber 600 may include a support attachment 610, a hoist unit 620 having a ratchet 625, a rod attachment 630, and a lower line 640. Unlike ground rod grabber 500, ground rod grabber 600 does not include an upper line. Rather, hoist unit 620 is directly coupled to support attachment 610. Also as illustrated, ground rod grabber 600 includes a coupling 635 for coupling lower line 640 to rod attachment 630. Unlike ground rod grabber 500, lower line 640 of ground rod grabber 600 forms a loop to which coupling 635 is coupled. As illustrated, coupling 635 is coupled to lower line 640 with a pulley 645. As illustrated, lower line 640 is threaded through the pulley 645. Operation of the hoist unit 620 may work to increase or decrease the size of the loop in the lower line 640. When coupled to the rod attachment 630, coupling 635 may maintain a fixed position relative to the rod attachment 630, while the pulley 645 may allow the coupling 635 to move along the lower line 640. For example, the coupling 635 may move along the lower line 640 as the size of the loop in the lower line 640 is changed by operation of the hoist unit 620. It should be appreciated that a larger loop in the lower line 640 corresponds to a larger distance between the hoist unit 620 and the rod attachment 630, and vice versa. Other aspects of ground rod grabber 600 are similar to those of ground rod grabber 500.

FIG. 7 illustrates an exemplary ground rod grabber 700 according to embodiments disclosed herein. Similar to ground rod grabber 500 and ground rod grabber 600, ground rod grabber 700 may include a support attachment 710, a hoist unit 720, a rod attachment 730, and a lower line 740. Unlike ground rod grabber 500, ground rod grabber 700 does not include an upper line. Rather, hoist unit 720 is directly coupled to support attachment 710. Also as illustrated, ground rod grabber 700 includes a coupling 735 for coupling lower line 740 to rod attachment 730. Unlike ground rod grabber 500, lower line 740 of ground rod grabber 700 forms multiple loops to which coupling 735 is coupled. As illustrated, coupling 735 is coupled to lower line 740 with a block of pulleys 745. As illustrated, an axial force exerted on the rope 726, directed away from hoist unit 720, is multiplied by the number of pulleys in the block of pulleys 745 to apply a lifting force to the coupling 735. As illustrated, lower line 740 is threaded multiple times through the block of pulleys 745. Operation of the hoist unit 720 may work to increase or decrease the size of the loops in the lower line 740. When coupled to the rod attachment 730, coupling 735 may maintain a fixed position relative to the rod attachment 730, while the block of pulleys 745 may allow the coupling 735 to move along the lower line 740. For example, the coupling 735 may move along the lower line 740 as the size of the loops in the lower line 740 is changed by operation of the hoist unit 720. It should be appreciated that a larger loop in the lower line 740 corresponds to a larger distance between the hoist unit 720 and the rod attachment 730, and vice versa. Other aspects of ground rod grabber 700 are similar to those of ground rod grabber 500 and ground rod grabber 600.

Each of the ground rod grabbers 500, 600, 700 include a hoist unit suspended between a support attachment and a rod attachment. Each of the ground rod grabbers 500, 600, 700 relies upon a top support, which may be an existing structure at the work site. Such suspension of the lift mechanism (i.e., hoist unit) by tension system (the lower line and possibly upper line) obviates any integrated support structure (e.g., tripod), as required by existing ground rod extraction techniques (such as winch-based solutions). The axial load forces necessary for extraction of a ground rod can be high, leading to bulky, heavy, and/or cumbersome integrated support structures. Extraction of a ground rod had previously necessitated application of axial load forces high above a worker's head, further leading to bulky, heavy, and/or cumbersome integrated support structures. In contrast, each of the ground rod grabbers 500, 600, 700 include only relatively light, compact, and portable components.

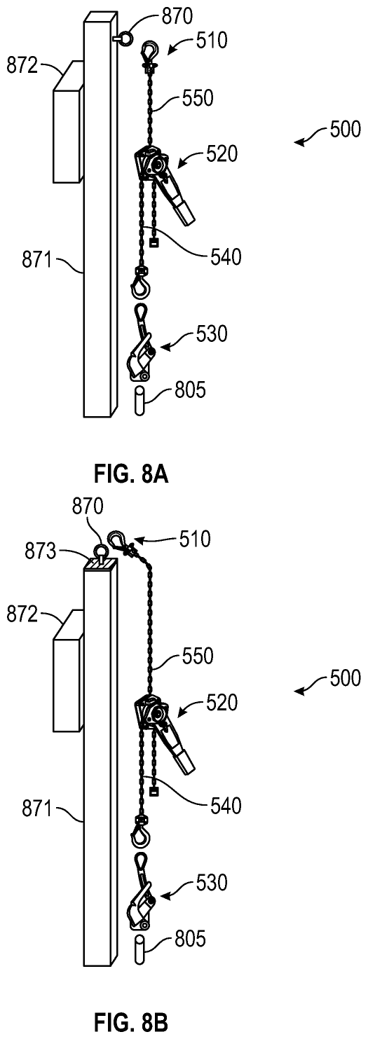

FIGS. 8A, 8B illustrate exemplary uses of ground rod grabber 500 to extract a ground rod 805 from the earth. The ground rod grabbers 600, 700 may be similarly used. The support attachment 510 of ground rod grabber 500 may be coupled to a top support 870, such as an eyebolt or similar attachment mechanism permanently coupled to panel pole 871. The panel pole 871 may be previously installed near (e.g., within about 2 feet of) a ground rod 805. The panel pole 871 is the primary support for the electric panel 872. Typically, an assembly consisting of a panel pole 871, an electric panel 872, and various connection conductors (that connect the assembly to utility lines) are collectively referred to as a temporary pole or “t-pole” assembly. T-pole assemblies often include an electric metering device as well (not shown here). The t-pole assemblies are typically delivered to and installed on construction sites by the electrical contractor technicians. A ground rod 805 is then driven into the earth near the t-pole assembly (e.g. within about 2 feet). The ground rod 805 is then connected to the panel 872 by means of grounding electrode conductors. Once the installation of the t-pole assembly and its ground rod is completed, the connections are made to the power distribution network by the utility company to provide temporary electric service to the site. The panel pole 871 may be a 4 inches×4 inches post that most commonly extends about 5 feet to about 7 feet above the earth. As illustrated in FIG. 8A, the top support 870 is coupled on the side of the panel pole 871 closest to the ground rod 805. Also as illustrated in FIG. 8A, the top support 870 is coupled near the top of the panel pole 871, for example 5 feet above the ground. In some embodiments, the top support 870 may be coupled on the top surface of panel pole 871 (as in FIG. 8B) or on a different side of panel pole 871. As illustrated in FIG. 8B, a protector 873 (e.g., a plate, a metal square washer, a pulley, a guide, a friction-reducing mechanism) may be installed between the top support 870 and the panel pole 871 to protect the top surface of panel pole 871 against potential damage (e.g. split wood) arising from contact with support attachment 510 and/or upper line 550 during ground rod extraction. It should be appreciated that coupling of the top support 870 to the top surface of the panel pole 871 permits extraction of ground rods 805 from any side of the panel pole 871. In some embodiments, the top support 870 (along with protector 873) may be coupled at or near the top of panel pole 871 prior to installation of panel pole 871 at the work site (e.g., near or at the same time that electric panel 872 is coupled to the panel pole 871). In some embodiments, the top support 870 (along with protector 873) may be coupled at or near the top of panel pole 871 after installation of panel pole 871 at the work site.

As illustrated in FIGS. 8A, 8B, the rod attachment 530 may couple to the exposed tip of the ground rod 805. Once the support attachment 510 is coupled to the top support 870, and the rod attachment 530 is coupled to the ground rod 805, the hoist unit 520 may apply axial load forces to the lower line 540 to efficiently extract the ground rod 805 from the earth. For example, the hoist unit 520 may be operated to exert an axial force on the lower line 540, and thereby exert a pulling force on the ground rod 805. In some embodiments, the ground rod 805 may be extracted from the earth. In some embodiments, the ground rod 805 may be extracted non-destructively. For example, a ground rod 805 that is non-destructively extracted may be sufficiently straight and unscathed to be subsequently reutilized as a ground rod.

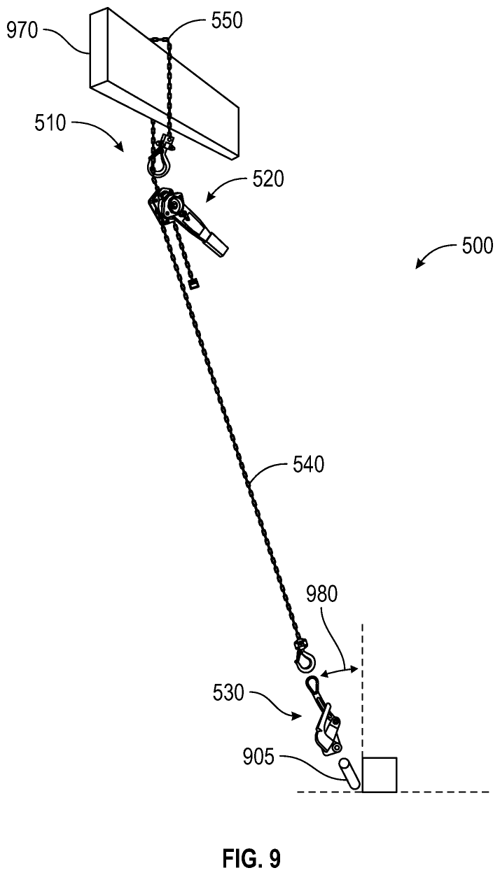

FIG. 9 illustrates use of the ground rod grabber 500 to extract a ground rod 905 from the earth. The ground rod grabbers 600, 700 may be similarly used. The support attachment 510 of ground rod grabber 500 may be coupled to a fixed top support 970, such as an overhead structural brace, beam, or pipe. The fixed top support 970 may be capable of withstanding a load of at least about 500 lbs. The upper line 550 of ground rod grabber 500 forms a loop about the top support 970. The loop is completed and secured with support attachment 510. The ground rod grabbers 600, 700 may be modified with the addition of an upper line for this type of use. The rod attachment 530 may couple to the exposed tip of the ground rod 905. Once the support attachment 510 is coupled to the top support 970, and the rod attachment 530 is coupled to the ground rod 905, the hoist unit 520 may apply axial load forces to the lower line 540 to efficiently extract the ground rod 905 from the earth. For example, the hoist unit 520 may be operated to exert an axial force on the lower line 540, and thereby exert a pulling force on the ground rod 905. In some embodiments, the ground rod 905 may be extracted from the earth. In some embodiments, the ground rod 905 may be extracted non-destructively. The use of a fixed top support 970 may alter the pull angle 980. For example, the use illustrated in FIG. 8, with a coupling to a panel pole as a top support, tends to create pull angles of about 0° to about 5°. In some instances, ground rod 905 may have been installed at a large angle (e.g., greater than 5°). The closer the pull angle 980 aligns the lower line 540 with the ground rod 905, the more efficiently the pull forces will be applied to the ground rod 905.

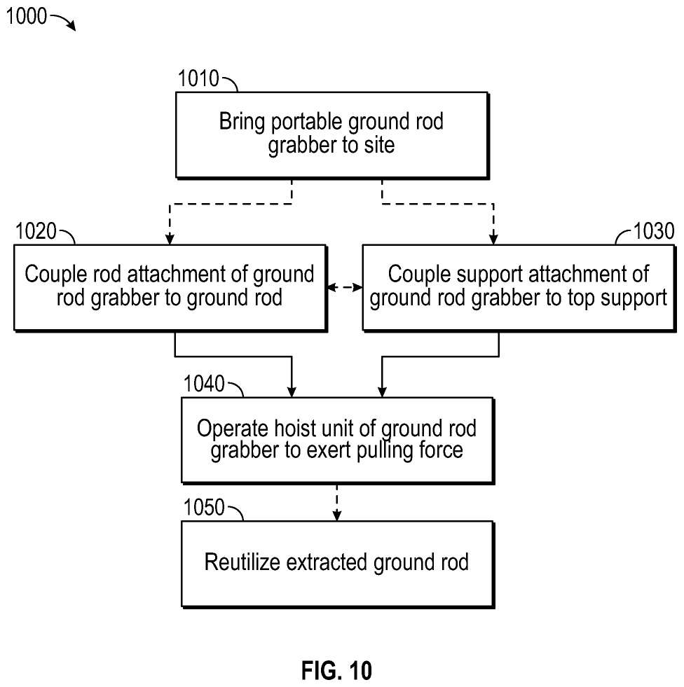

FIG. 10 illustrates an exemplary method 1000 for utilizing a ground rod grabber, such as ground rod grabbers 500, 600, 700. In some embodiments, the method 1000 may begin at box 1010, wherein the ground rod grabber is brought to the site. For example, the ground rod grabber may be transported in a small-load transport vehicle. As another example, the ground rod grabber may be carried to a proximity of a ground rod by a single-man carry. In some embodiments, the method 1000 may continue at box 1020, wherein the rod attachment of the ground rod grabber is coupled to the ground rod. In some embodiments, the method 1000 may continue at box 1030, wherein the support attachment of the ground rod grabber is coupled to the top support. The actions of box 1020 and box 1030 may occur in any order, and/or simultaneously. The method 1000 may continue at box 1040, wherein the hoist unit of the ground rod grabber may be operated to exert a pulling force. For example, the hoist unit may be operated to exert an axial force on the lower line, and thereby exert a pulling force on the ground rod. In some embodiments, the ground rod may be extracted from the earth. In some embodiments, the ground rod may be extracted non-destructively. In some embodiments, after the ground rod is extracted, the method 1000 may continue at block 1050, wherein the ground rod is reutilized.

In an embodiment, a ground rod grabber includes a rod attachment configured to couple the ground rod grabber to a ground rod; a support attachment configured to couple the ground rod grabber to a top support, such that, when coupled, the support attachment retains at least two dimensions of freedom relative to the top support; a lower line coupled to the rod attachment; and a hoist unit through which the lower line is threaded.

In one or more embodiments disclosed herein, the at least two dimensions of freedom comprise rotational motion about a pair of orthogonal axes passing through the support attachment.

In one or more embodiments disclosed herein, the ground rod grabber also includes an upper line coupled between the support attachment and the hoist unit.

In one or more embodiments disclosed herein, the hoist unit comprises a ratchet.

In one or more embodiments disclosed herein, the lower line is coupled to the rod attachment with a coupling at a lower end of the lower line.

In one or more embodiments disclosed herein, the ground rod grabber is portable.

In one or more embodiments disclosed herein, the ground rod grabber comprises weight and size compatible for single-man lift according to industry guidelines.

In one or more embodiments disclosed herein, the ground rod grabber comprises weight and size compatible for small-load vehicle transport according to industry guidelines.

In an embodiment, a ground rod grabber includes a support attachment configured to couple the ground rod grabber to a top support; an upper line coupled at a first end to the support attachment; a hoist unit coupled to the upper line at a second end of the upper line; a rod attachment configured to couple the ground rod grabber to a ground rod; and a lower line coupled at a third end to the rod attachment and threaded through the hoist unit.

In one or more embodiments disclosed herein, the support attachment is configured to provide the ground rod grabber at least two dimensions of freedom relative to the top support.

In one or more embodiments disclosed herein, the at least two dimensions of freedom comprise rotational motion about a pair of orthogonal axes passing through the support attachment.

In one or more embodiments disclosed herein, the hoist unit comprises a ratchet.

In one or more embodiments disclosed herein, the lower line is coupled to the rod attachment with a coupling at a lower end of the lower line.

In one or more embodiments disclosed herein, the ground rod grabber is portable.

In one or more embodiments disclosed herein, the ground rod grabber comprises weight and size compatible for single-man lift according to industry guidelines.

In one or more embodiments disclosed herein, the ground rod grabber comprises weight and size compatible for small-load vehicle transport.

In an embodiment, a method of ground rod extraction includes coupling a ground rod grabber to a ground rod with a rod attachment, wherein the ground rod grabber comprises: the rod attachment; a support attachment; a hoist unit; and a lower line threaded through the hoist unit; coupling the ground rod grabber to a top support with the support attachment such that, when coupled, the support attachment retains at least two dimensions of freedom relative to the top support; and operating the hoist unit to exert pulling force on the lower line.

In one or more embodiments disclosed herein, operating the hoist unit comprises operating a ratchet.

In one or more embodiments disclosed herein, the lower line is coupled to the rod attachment with a coupling at a lower end of the lower line.

In one or more embodiments disclosed herein, coupling the ground rod grabber to the ground rod comprises single-hand manipulation.

In one or more embodiments disclosed herein, coupling the ground rod grabber to the top support comprises single-hand manipulation.

In one or more embodiments disclosed herein, the top support is coupled to a panel pole.

In one or more embodiments disclosed herein, the ground rod grabber is portable.

In one or more embodiments disclosed herein, the method also includes transporting the ground rod grabber with a small-load transport vehicle.

In one or more embodiments disclosed herein, the method also includes utilizing a single-man carry to position the ground rod grabber proximate the ground rod.

In one or more embodiments disclosed herein, the method also includes extracting the ground rod non-destructively.

In one or more embodiments disclosed herein, the method also includes, after extracting the ground rod, reutilizing the ground rod.

In an embodiment, a method of ground rod extraction includes coupling a ground rod grabber to a top support with a support attachment, wherein the ground rod grabber comprises: the support attachment; an upper line coupled at a first end to the support attachment; a hoist unit coupled to the upper line at a second end of the upper line; a rod attachment; and a lower line coupled at a third end to the rod attachment and threaded through the hoist unit; coupling the ground rod grabber to a ground rod with the rod attachment; and operating the hoist unit to exert pulling force on the lower line.

In one or more embodiments disclosed herein, operating the hoist unit comprises operating a ratchet.

In one or more embodiments disclosed herein, the lower line is coupled to the rod attachment with a coupling at a lower end of the lower line.

In one or more embodiments disclosed herein, coupling the ground rod grabber to the top support comprises single-hand manipulation.

In one or more embodiments disclosed herein, the top support is coupled to a panel pole.

In one or more embodiments disclosed herein, coupling the ground rod grabber to the ground rod comprises single-hand manipulation.

In one or more embodiments disclosed herein, the ground rod grabber is portable.

In one or more embodiments disclosed herein, the method also includes transporting the ground rod grabber with a small-load transport vehicle.

In one or more embodiments disclosed herein, the method also includes utilizing a single-man carry to position the ground rod grabber proximate the ground rod.

In one or more embodiments disclosed herein, the method also includes extracting the ground rod non-destructively.

In one or more embodiments disclosed herein, the method also includes, after extracting the ground rod, reutilizing the ground rod.

In an embodiment, a ground rod grabber includes a tube having a length-wise window; a threaded shaft disposed within the tube; a nut threaded on the threaded shaft within the tube; and a lifting lug coupled to the nut, extending through the window, and having a hole sized to fit a ground rod.

In one or more embodiments disclosed herein, the ground rod grabber also includes a tool tip at an end of the threaded shaft.

In one or more embodiments disclosed herein, the tool tip comprises a drill-bit tip.

In one or more embodiments disclosed herein, the ground rod grabber also includes a base plate at a lower end of the tube.

In one or more embodiments disclosed herein, the base plate comprises a notch on a same side of the tube as the window.

In one or more embodiments disclosed herein, the ground rod grabber is portable.

In one or more embodiments disclosed herein, the ground rod grabber comprises weight and size compatible for single-man lift according to industry guidelines.

In one or more embodiments disclosed herein, the ground rod grabber comprises weight and size compatible for small-load vehicle transport according to industry guidelines.

While the foregoing is directed to embodiments of the present disclosure, other and further embodiments of the disclosure may be devised without departing from the basic scope thereof, and the scope thereof is determined by the claims that follow.

1. A ground rod grabber comprising:
a support attachment configured to couple the ground rod grabber to a top support;
an upper line coupled at a first end to the support attachment;
a hoist unit coupled to the upper line at a second end of the upper line;
a rod attachment configured to couple the ground rod grabber to a ground rod; and
a lower line coupled at a third end to the rod attachment and threaded through the hoist unit.

2. The ground rod grabber of claim 1, wherein the support attachment is configured to provide the ground rod grabber at least two dimensions of freedom relative to the top support.

3. The ground rod grabber of claim 2, wherein the at least two dimensions of freedom comprise rotational motion about a pair of orthogonal axes passing through the support attachment.

4. The ground rod grabber of claim 1, wherein the hoist unit comprises a ratchet.

5. The ground rod grabber of claim 1, wherein the lower line is coupled to the rod attachment with a coupling at a lower end of the lower line.

6. The ground rod grabber of claim 1, wherein the ground rod grabber is portable.

7. The ground rod grabber of claim 1, wherein the ground rod grabber comprises weight and size compatible for single-man lift according to industry guidelines.

8. The ground rod grabber of claim 1, wherein the ground rod grabber comprises weight and size compatible for small-load vehicle transport.

9. A method of ground rod extraction, the method comprising:
coupling a ground rod grabber to a ground rod with a rod attachment, wherein the ground rod grabber comprises:
the rod attachment;
a support attachment;
a hoist unit; and
a lower line threaded through the hoist unit;
coupling the ground rod grabber to a top support with the support attachment such that, when coupled, the support attachment retains at least two dimensions of freedom relative to the top support; and
operating the hoist unit to exert pulling force on the lower line.

10. The method of claim 9, wherein operating the hoist unit comprises operating a ratchet.

11. The method of claim 9, wherein the lower line is coupled to the rod attachment with a coupling at a lower end of the lower line.

12. The method of claim 9, wherein coupling the ground rod grabber to the ground rod comprises single-hand manipulation.

13. The method of claim 9, wherein coupling the ground rod grabber to the top support comprises single-hand manipulation.

14. The method of claim 9, wherein the top support is coupled to a panel pole.

15. The method of claim 9, wherein the ground rod grabber is portable.

16. The method of claim 9, further comprising transporting the ground rod grabber with a small-load transport vehicle.

17. The method of claim 9, further comprising utilizing a single-man carry to position the ground rod grabber proximate the ground rod.

18. The method of claim 9, further comprising extracting the ground rod non-destructively.

19. The method of claim 18, further comprising, after extracting the ground rod, reutilizing the ground rod.

20. A ground rod grabber, comprising:
a tube having a length-wise window;
a threaded shaft disposed within the tube;
a nut threaded on the threaded shaft within the tube; and
a lifting lug coupled to the nut, extending through the window, and having a hole sized to fit a ground rod.
